(19) United States
(12) Patent Application Publication
(10) Pub. No.: US 2025/0234238 A1
(43) Pub. Date: Jul. 17, 2025

(54) SYSTEMS AND METHODS FOR ADAPTIVE POLICY CONTROL IN CELLULAR NETWORKS

(71) Applicant: Verizon Patent and Licensing Inc., Basking Ridge, NJ (US)

(72) Inventors: Raghuram Parvataneni, Frisco, TX (US); Parry Cornell Booker, Sunnyvale, TX (US); Niranjan B. Avula, Frisco, TX (US)

(21) Appl. No.: 18/415,087

(22) Filed: Jan. 17, 2024

(51) Int. Cl. H04W 28/02

(52) U.S. Cl. CPC H04W 28/0268

(57) ABSTRACT

A device may include a processor configured to collect user behavior data associated with a user equipment (UE) device and determine a user behavior pattern for the UE device based on the collected user behavior data. The processor may be further configured to generate a policy in a core network for the UE device based on the determined user behavior pattern for the UE device, wherein the core network manages a communication session for the UE device via a Radio Access Network (RAN), and provide the generated policy to a Policy Control Function (PCF) in the core network to apply to the communication session for the UE device.

### BACKGROUND INFORMATION

To satisfy the needs and demands of users of mobile communication devices, providers of wireless communication services continue to improve and expand available services as well as networks used to deliver such services. One aspect of such improvements includes enabling mobile communication devices to access and use various services via the provider's communication network. Managing different types of communication services for wireless communication devices may pose various challenges.

### BRIEF DESCRIPTION OF THE DRAWINGS

FIG. 1 illustrates an environment according to an implementation described herein;

FIG. 2 illustrates exemplary components of a core network according to an implementation described herein;

FIG. 3 illustrates exemplary components of a device that may be included in a network component according to an implementation described herein;

FIG. 4 illustrates exemplary components of an adaptive policy system according to an implementation described herein;

FIG. 5 illustrates exemplary components of a user behavior database according to an implementation described herein;

FIG. 6 illustrates exemplary components of a group behavior database according to an implementation described herein;

FIG. 7 illustrates a flowchart of a process for generating a user policy in a core network according to an implementation described herein;

FIG. 8 illustrates a flowchart of a process for generating a group user policy in a core network according to an implementation described herein;

FIG. 9 illustrates a first exemplary signal flow diagram according to an implementation described herein; and

FIG. 10 illustrates a second exemplary signal flow diagram according to an implementation described herein.

### DETAILED DESCRIPTION OF PREFERRED EMBODIMENTS

The following detailed description refers to the accompanying drawings. The same reference numbers in different drawings identify the same or similar elements.

A cellular wireless network enables user equipment (UE) devices to connect to networks via a Radio Access Network (RAN) and a core network in order to communicate with other devices connected to the RAN, communicate with devices in other networks, access applications or services hosted by a provider in the core network, and/or make use of other types of wireless communication services. For example, Fifth Generation (5G) core network may implement different types of services for UE devices, such as, for example, an enhanced Mobile Broadband (eMBB) service for Voice over Internet Protocol (VOIP) telephone calls and/or data sessions for accessing Internet websites; a massive Internet of Things (mIoT) service for Internet of Things (IoT) devices; an Ultra-Reliable Low Latency Communication (URLLC) service for mission critical devices such as medical monitoring devices, autonomous vehicles, industrial automation, etc.; and/or other types of wireless communication services. Each type of communication service may be associated with a different set of requirements.

In order to establish a communication session, a UE device may establish a Protocol Data Unit (PDU) session in the core network via the RAN. The UE device may then establish one or more data flows in the PDU session. Each data flow may be associated with a Quality of Service (QOS) and/or other types of service requirements. Each PDU session and/or data flow may be associated with one or more policies. Each policy may, for example, establish a set of QoS parameters to be maintained for the data flow, a filter to be applied to the data flow, a routing rule to be applied to the data flow, a set of key performance indicators (KPIs) values to monitor and/or report for the data flow, and/or apply another rule to the data flow. In a 5G core network, policies for data flows may be managed by a Policy Control Function (PCF).

Policies for different types of data flows may be created manually. For example, a PCF may include a master list of policies for different types of data flows associated with different QoS requirements. The master list of policies may be created and updated manually by an administrator and may undergo review and testing each time the master list of policies is updated. Manually maintaining a list of policies for a core network and/or RAN may be inefficient and consume network and/or human resources.

Implementations described herein relate to systems and methods for adaptive policy control in a core network and/or a RAN associated with the core network. An adaptive policy system may be configured to generate a core network policy and/or RAN policy for a user, and/or for a particular group of users, based on a behavior pattern associated with the user and/or the particular group of users. For example, the adaptive policy system may be configured to collect user behavior data associated with a UE device, determine a user behavior pattern for the UE device based on the collected user behavior data, generate a policy for the UE device in a core network managing a communication session for the UE device via a RAN based on the determined user behavior pattern for the UE device, and provide the generated policy to a PCF in the core network to apply to the communication session for the UE device. The adaptive policy system may provide the generated policy to the PCF via an interface provided by the PCF to receive dynamic policy control information from the core network.

The user behavior data may include information identifying, for a location and a time period, and at least one of a QoS parameter for a data flow associated with the UE device, a network slice used by the UE device, a Multi-Access Edge Computing (MEC) service used by the UE device, an application used by the UE device, a core network KPI value for a data flow associated with the UE device, a RAN KPI value for a data flow associated with the UE device, and/or other types of information associated with the UE device.

The generated policy for the UE device in the core network may include a policy to reserve resources for at least one of guaranteeing a QoS parameter value during a time period, a data flow in network slice during the time period, a data flow to a MEC service during the time period, guaranteeing a KPI value for a data flow during the time period, guaranteeing a minimum throughput for a data flow during the time period, applying a filter to a data flow during the time period, reporting KPI value for a data flow during the time period, and/or reserve resource for another type of policy. In some implementations, generating the policy for the UE device in the core network may include using a Deep Q-Learning Network (DQN) to generate the policy for the UE device in the core network based on the user behavior pattern for the UE device.

The adaptive policy system may be further configured to select a group of UE devices, collect group user behavior data associated with the group of UE devices, determine a group user behavior pattern for the group of UE device based on the collected group user behavior data, generate a user group policy for the group of UE devices in the core network, and provide the generated user group policy to the PCF to apply to communication sessions associated with the group of UE devices.

Selecting the group of UE devices may include selecting a set of UE devices managed by an enterprise, selecting a set of UE devices associated with a same location, selecting a set of UE devices attached to a same base station, selecting a set of UE devices that installed a same application, selecting a set of UE devices associated with a same device type, selecting a set of UE devices associated with a same operating system, selecting a set of UE devices associated with a same radio frequency transceiver processor, and/or selecting a set of UE devices based on a different criterion. Additionally, or alternatively, selecting the group of UE devices may include identifying a cluster of UE devices by applying a clustering algorithm.

The adaptive policy system may be further configured to provide an interface to an Application Function (AF) to enable the AF to request the policy for the UE device in the core network and receive, from the AF via the provided interface, a request to generate a user group policy for a group of UE devices in the core network for a time period. Additionally, the adaptive policy system may be configured to receive performance information associated with the generated policy from the core network and adjust the generated policy for the UE device in the core network based on the received performance information using a reinforcement learning model.

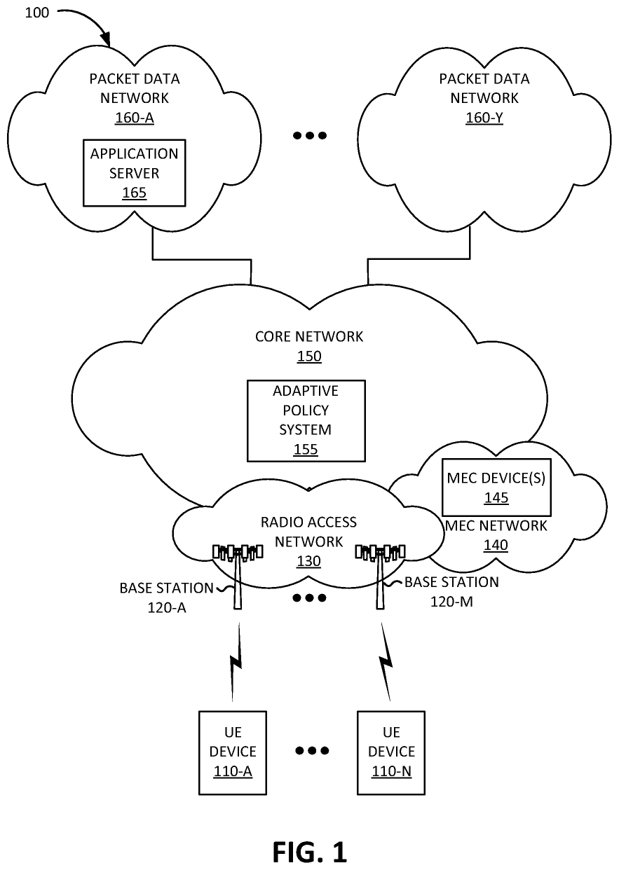

FIG. 1 is a diagram of an exemplary environment 100 in which the systems and/or methods, described herein, may be implemented. As shown in FIG. 1, environment 100 may include UE devices 110-A to 110-N (referred to herein collectively as “UE devices 110” and individually as “UE device 110”), a RAN 130 that includes base stations 120-A to 120-M (referred to herein collectively as “base stations 120” and individually as “base station 120”), a Multi-Access Edge Computing (MEC) network 140, a core network 150, and packet data networks (PDNs) 160-A to 160-Y (referred to herein collectively as “PDNs 160” and individually as “PDN 160”).

UE device 110 may include any mobile device with cellular wireless communication functionality. UE device 110 may include a handheld wireless communication device (e.g., a mobile phone, a smart phone, a tablet device, etc.); a wearable computer device (e.g., a head-mounted display computer device, a wristwatch computer device, etc.); a laptop computer, a tablet computer, a portable gaming system, and/or another type of portable computer; a WiFi access point (AP); a Fixed Wireless Access (FWA) device; and/or any other type of mobile computer device with cellular wireless communication capabilities. In some implementations, UE device 110 may communicate using machine-to-machine (M2M) communication, such as Machine Type Communication (MTC), and/or another type of M2M communication for IoT applications.

Base station 120 may include a 5G New Radio (NR) base station (e.g., a gNodeB) and/or a Fourth Generation (4G) Long Term Evolution (LTE) base station (e.g., an eNodeB). Each base station 120 may include devices and/or components configured to enable cellular wireless communication with UE devices 110. For example, base station 120 may include a radio frequency (RF) transceiver configured to communicate with UE devices using a 5G NR air interface using a 5G NR protocol stack, a 4G LTE air interface using a 4G LTE protocol stack, and/or using another type of cellular air interface.

RAN 130 may include base stations 120 and be managed by a provider of wireless communication services. RAN 130 may enable UE devices 110 to connect to core network 150 via base stations 120 using cellular wireless signals. For example, RAN 130 may include one or more central units (CUs), distributed units (DUs), and/or Radio Units (RUs) (not shown in FIG. 1) that enable and manage connections from RUs to core network 150. RAN 130 may include features associated with an LTE Advanced (LTE-A) network and/or a 5G core network or other advanced network, such as management of 5G NR base stations; carrier aggregation; advanced or massive multiple-input and multiple-output (MIMO) configurations (e.g., an 8×8 antenna configuration, a 16×16 antenna configuration, a 256×256 antenna configuration, etc.); cooperative MIMO (CO-MIMO); relay stations; Heterogeneous Networks (HetNets) of overlapping small cells and macrocells; Self-Organizing Network (SON) functionality; MTC functionality, such as 1.4 Megahertz (MHz) wide enhanced MTC (eMTC) channels (also referred to as category Cat-M1), Low Power Wide Area (LPWA) technology such as Narrow Band (NB) IoT (NB-IoT) technology, and/or other types of MTC technology; and/or other types of LTE-A and/or 5G functionality.

MEC network 140 may be associated with one or more base stations 120 and may provide MEC services for UE devices 110 attached to the base stations 120. MEC network 140 may be in proximity to base stations 120 from a geographic and network topology perspective, thus enabling low latency services to be provided to UE devices 110. As an example, MEC network 140 may be located on the same site as base station 120. As another example, MEC network 140 may be geographically closer to one of base stations 120 and reachable via fewer network hops and/or fewer switches, than other base stations 120.

MEC network 140 may include one or more MEC devices 145. MEC devices 145 may provide MEC services to UE devices 110. A MEC service may include, for example, a low-latency microservice associated with a particular application, a microservice associated with a virtualized network function (VNF) of core network 150, a cloud computing service, such as cache storage service, artificial intelligence (AI) accelerator service, machine learning service, an image processing service, a data compression service, a locally centralized gaming service, a Graphics Processing Units (GPUs) and/or other types of hardware accelerator service, and/or other types of cloud computing services.

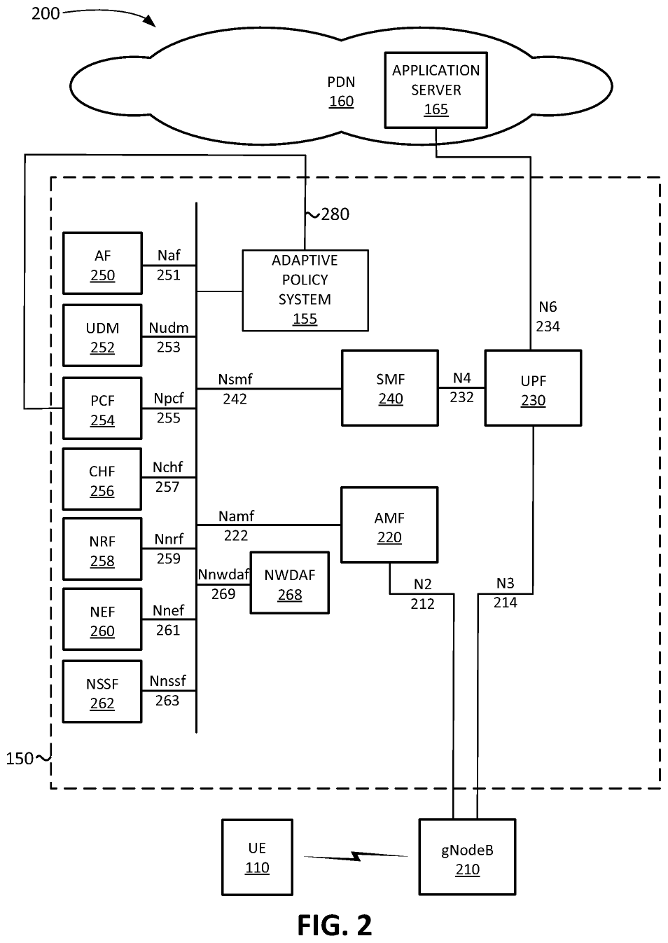

Core network 150 may be managed by the provider of cellular wireless communication services and may manage communication sessions of subscribers connecting to core network 150 via RAN 130. For example, core network 150 may establish an Internet Protocol (IP) connection between UE devices 110 and PDN 160. In some implementations, core network 150 may include a 5G core network. Exemplary components of a 5G core network are described below with reference to FIG. 2. In other implementations, core network 150 may include a 4G core network.

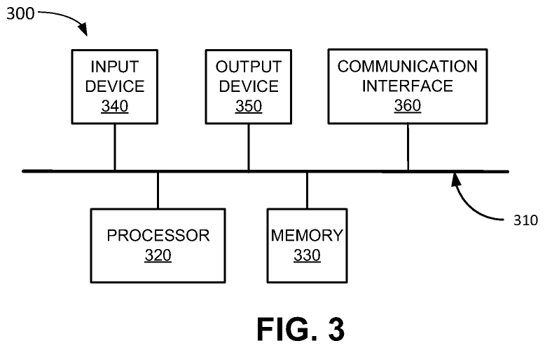

The components of core network 150 may be implemented as dedicated hardware components and/or as VNFs implemented on top of a common shared physical infrastructure using Software Defined Networking (SDN). For example, an SDN controller may implement one or more of the components of core network 150 using an adapter implementing a VNF virtual machine, a Cloud-Native Network Function (CNF) container, an event driven serverless architecture interface, and/or another type of SDN architecture. The common shared physical infrastructure may be implemented using one or more devices 300 described below with reference to FIG. 3 in a cloud computing center associated with core network 150. Additionally, or alternatively, some, or all, of the common shared physical infrastructure may be implemented using one or more devices 300 included in MEC network 140.

Core network 150 may include an adaptive policy system 155. Adaptive policy system 155 may include one or more computer devices, such as server devices and/or cloud computing devices, configured to generate an adaptive policy for a core network for a UE device 110 and/or for a group of UE devices 110. Adaptive policy system 155 may generate a policy for a time period for UE device 110 based on user behavior data and/or generate a group user policy for a time period for a group of UE devices 110 based on group user behavior data for the group of UE devices 110. Adaptive policy system 155 may define a group of UE devices 110 based on one or more parameters, by applying a clustering algorithm, based on information received from application server 165, and/or by applying another group defining process.

PDNs 160-A to 160-Y may each be associated with a Data Network Name (DNN) in 5G, and/or an Access Point Name (APN) in 4G. UE device 110 may request a connection to PDN 160 using a DNN or an APN. For example, UE device 110 request a connection to an application server 165 (shown in PDN 160-A for illustrative purposes). PDN 160 may include, and/or be connected to, a local area network (LAN), a wide area network (WAN), a metropolitan area network (MAN), an autonomous system (AS) on the Internet, an optical network, a cable television network, a satellite network, a wireless network, an ad hoc network, a telephone network (e.g., the Public Switched Telephone Network (PSTN) or a cellular network), an intranet, or a combination of networks.

Application server 165 may include one or more computer devices that host one or more applications used by UE device 110. For example, application server 165 may host video and/or audio content and may stream video and/or audio to UE device 110, may host a server for a game played by the user of UE device 110, may provide cloud computing services to UE device 110, may host a social media or another type of website, and/or may host another type of application and/or provide another type of service. Application server 165 may send a request to generate a policy for a group of UE devices 110 to adaptive policy system 155 and/or may receive policy information associated with one or more UE devices 110 from adaptive policy system 155.

Although FIG. 1 shows exemplary components of environment 100, in other implementations, environment 100 may include fewer components, different components, differently arranged components, or additional components than depicted in FIG. 1. Additionally, or alternatively, one or more components of environment 100 may perform functions described as being performed by one or more other components of environment 100.

FIG. 2 illustrates an implementation 200 of core network 150 as a 5G core network. As shown in FIG. 2, implementation 200 includes UE device 110, gNodeB 210, core network 150, and PDN 160. Core network 150 may include an Access and Mobility Function (AMF) 220, a User Plane Function (UPF) 230, a Session Management Function (SMF) 240, an Application Function (AF) 250, a Unified Data Management (UDM) 252, a PCF 254, a Charging Function (CHF) 256, a Network Repository Function (NRF) 258, a Network Exposure Function (NEF) 260, a Network Slice Selection Function (NSSF) 262, and a Network Data Analytics Function (NWDAF) 268. Core network 150 may further include adaptive policy system 155.

While FIG. 2 depicts a single AMF 220, UPF 230, SMF 240, AF 250, UDM 252, PCF 254, CHF 256, NRF 258, NEF 260, NSSF 262, and NWDAF 268 for illustration purposes, in practice, core network 150 may include multiple AMFs 220, UPFs 230, SMFs 240, AFs 250, UDMs 252, PCFs 254, CHFs 256, NRFs 258, NEFs 260, NSSFs 262, and/or NWDAFs 268. gNodeB 210 may be part of RAN 130 and may include base station 120.

AMF 220 may perform registration management, connection management, reachability management, mobility management, lawful intercepts, session management messages transport between UE device 110 and SMF 240, access authentication and authorization, location services management, functionality to support non-3GPP access networks, and/or other types of management processes. AMF 220 may be accessible by other function nodes via an Namf interface 222.

UPF 230 may maintain an anchor point for intra/inter-Radio Access Technology (RAT) mobility, maintain an external PDU point of interconnect to a particular PDN 160, perform packet routing and forwarding, perform the user plane part of policy rule enforcement, perform packet inspection, perform lawful intercept, perform traffic usage reporting, perform QoS handling in the user plane, perform uplink traffic verification, perform transport level packet marking, perform downlink packet buffering, forward an “end marker” to a RAN node (e.g., gNodeB 210), and/or perform other types of user plane processes. UPF 230 may communicate with SMF 240 using an N4 interface 232 and connect to PDN 160 using an N6 interface 234.

SMF 240 may perform session establishment, session modification, and/or session release, apply policies received from PCF 254 to data flows, perform IP address allocation and management, perform Dynamic Host Configuration Protocol (DHCP) functions, perform selection and control of UPF 230, configure traffic steering at UPF 230 to guide the traffic to the correct destinations, perform lawful intercepts, charge data collection, support charging interfaces, control and coordinate of charging data collection, terminate session management parts of Non-Access Stratum messages, perform downlink data notification, manage roaming functionality, and/or perform other types of control plane processes for managing user plane data. SMF 240 may be accessible via an Nsmf interface 242.

AF 250 may provide services associated with a particular application, such as, for example, an application for influencing traffic routing, an application for accessing NEF 260, an application for interacting with a policy framework for policy control, and/or other types of applications. AF 250 may be accessible via an Naf interface 251, also referred to as an NG5 interface. In some implementations, AF 250 may correspond to, or interface with, application server 165. For example, application server 165 may send a request to adaptive policy system 155, via AF 250, to generate a policy for one or more UE devices 110 and/or receive, via AF 250, information relating to a generated policy from adaptive policy system 155.

UDM 252 may maintain subscription information for UE devices 110, manage subscriptions, generate authentication credentials, handle user identification, perform access authorization based on subscription data, maintain service and/or session continuity by maintaining assignment of SMF 240 for ongoing sessions, support lawful intercept functionality, and/or perform other processes associated with managing user data. UDM 252 may interface with a Unified Data Repository (UDR) that stores, in a subscription profile associated with a particular UE device 110, a list of network slices which the particular UE device 110 is allowed to access. UDM 252 may be accessible via a Nudm interface 253.

PCF 254 may support policies to control network behavior, provide policy rules to control plane functions (e.g., to SMF 240) and/or access and mobility functions (e.g., to AMF 220), provide a UE device Route Selection Policy (URSP) to UE device 110, access subscription information relevant to policy decisions, perform policy decisions, and/or perform other types of processes associated with policy enforcement. PCF 254 may receive an adaptive policy for UE device 110, and/or for a group of UE devices 110, from adaptive policy system 155 via a Dynamic Policy Control Interface (DPCI) 280. PCF 254 may be accessible via Npcf interface 255. CHF 256 may perform charging and/or billing functions for core network 140. CHF 256 may be accessible via Nchf interface 257.

NRF 258 may support a service discovery function and maintain profiles of available network function (NF) instances and their supported services. An NF profile may include an NF ID, an NF type, a Public Land Mobile Network (PLMN) ID associated with the NF, network slice IDs associated with the NF, capacity information for the NF, service authorization information for the NF, supported services associated with the NF, endpoint information for each supported service associated with the NF, and/or other types of NF information. NRF 258 may be accessible via an Nnrf interface 259.

NEF 260 may expose services, capabilities, and/or events to other NFs, including third party NFs, AFs 250, edge computing NFs, and/or other types of NFs. Furthermore, NEF 260 may secure provisioning of information from external applications to core network 150, translate information between core network 150 and devices/networks external to core network 150, support a Packet Flow Description (PFD) function, and/or perform other types of network exposure functions. In some implementations, NEF 260 may expose capabilities of core network 150 to adaptive policy system 155, enabling adaptive policy system 155 to communicate with an NF with which adaptive policy system 155 does not have a direct interface. NEF 260 may be accessible via an Nnef interface 261.

NSSF 262 may select a set of network slice instances to serve a particular UE device 110, determine network slice selection assistance information (NSSAI), determine a particular AMF 220 to serve a particular UE device 110, and/or perform other types of processing associated with network slice selection or management. NSSF 262 may provide a list of allowed slices for a particular UE device 110 to UDM 252 to store in a subscription profile associated with the particular UE device 110. NSSF 262 may be accessible via Nnssf interface 263.

NWDAF 268 may collect analytics information associated with RAN 130 and/or core network 150. For example, NWDAF 268 may collect and/or obtain KPI information relating to UE device 110 in RAN 130 from eNodeB 210. For example, NWDAF 268 may obtain RAN KPI information relating to UE device 110 from gNodeB 210. NWDAF 268 may further collect and/or obtain KPI information relating to UE device 110 in core network 150. For example, NWDAF 268 may obtain core network KPI information relating to UE device 110 from UPF 230, SMF 240, and/or PCF 254. NWDAF 268 may provide obtained RAN KPI information and/or core network KPI information to adaptive policy system 155. NWDAF 268 may be accessible via Nnwdaf interface 269.

Although FIG. 2 shows exemplary components of core network 150, in other implementations, core network 150 may include fewer components, different components, differently arranged components, or additional components than depicted in FIG. 2. Additionally, or alternatively, one or more components of core network 150 may perform functions described as being performed by one or more other components of core network 150. Furthermore, while particular interfaces have been described with respect to particular function nodes in FIG. 2, additionally, or alternatively, core network 150 may include a reference point architecture that includes point-to-point interfaces between particular function nodes.

Moreover, in other implementations, core network 150 may include a Fourth Generation (4G) Evolved Packet Core (EPC) network that includes a Mobility Management Entity (MME), a Serving Gateway (SGW), a PDN Gateway (PGW), a Policy and Charging Rules Function (PCRF), and/or other 4G EPC components. In a 4G EPC network, the PCRF may perform one or more functions described herein as being performed by PCF 254 in a 5G core network.

FIG. 3 is a diagram illustrating example components of a device 300 according to an implementation described herein. Each of the components of FIGS. 1 and/or 2 may include, or be implemented on, one or more devices 300. As shown in FIG. 3, device 300 may include a bus 310, a processor 320, a memory 330, an input device 340, an output device 350, and a communication interface 360.

Bus 310 may include a path that permits communication among the components of device 300. Processor 320 may include any type of single-core processor, multi-core processor, microprocessor, latch-based processor, central processing unit (CPU), graphics processing unit (GPU), tensor processing unit (TPU), hardware accelerator, and/or processing logic (or families of processors, microprocessors, and/or processing logics) that interprets and executes instructions. In other embodiments, processor 320 may include an application-specific integrated circuit (ASIC), a field-programmable gate array (FPGA), and/or another type of integrated circuit or processing logic.

Memory 330 may include any type of dynamic storage device that may store information and/or instructions, for execution by processor 320, and/or any type of non-volatile storage device that may store information for use by processor 320. For example, memory 330 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 340 may allow an operator to input information into device 300. Input device 340 may include, for example, a keyboard, a mouse, a pen, a microphone, a remote control, an audio capture device, an image and/or video capture device, a touch-screen display, and/or another type of input device. In some implementations, device 300 may be managed remotely and may not include input device 340. In other words, device 300 may be “headless” and may not include a keyboard, for example.

Output device 350 may output information to an operator of device 300. Output device 350 may include a display, a printer, a speaker, and/or another type of output device. For example, device 300 may include a display, which may include a liquid-crystal display (LCD) for displaying content to the user. In some implementations, device 300 may be managed remotely and may not include output device 350. In other words, device 300 may be “headless” and may not include a display, for example.

Communication interface 360 may include a transceiver that enables device 300 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 360 may include a transmitter that converts baseband signals to radio frequency (RF) signals and/or a receiver that converts RF signals to baseband signals. Communication interface 360 may be coupled to an antenna for transmitting and receiving RF signals.

Communication interface 360 may include a logical component that includes input and/or output ports, input and/or output systems, and/or other input and output components that facilitate the transmission of data to other devices. For example, communication interface 360 may include a network interface card (e.g., Ethernet card) for wired communications and/or a wireless network interface (e.g., a WiFi) card for wireless communications. Communication interface 360 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

As will be described in detail below, device 300 may perform certain operations relating to adaptive policy control in a core network associated with a RAN. Device 300 may perform these operations in response to processor 320 executing software instructions contained in a computer-readable medium, such as memory 330. A computer-readable medium may be defined as a non-transitory memory device. A memory device may be implemented within a single physical memory device or spread across multiple physical memory devices. The software instructions may be read into memory 330 from another computer-readable medium or from another device. The software instructions contained in memory 330 may cause processor 320 to perform processes described herein. Alternatively, hardwired circuitry may be used in place of, or in combination with, software instructions to implement processes described herein. Thus, implementations described herein are not limited to any specific combination of hardware circuitry and software.

Although FIG. 3 shows exemplary components of device 300, in other implementations, device 300 may include fewer components, different components, additional components, or differently arranged components than depicted in FIG. 3. Additionally, or alternatively, one or more components of device 300 may perform one or more tasks described as being performed by one or more other components of device 300.

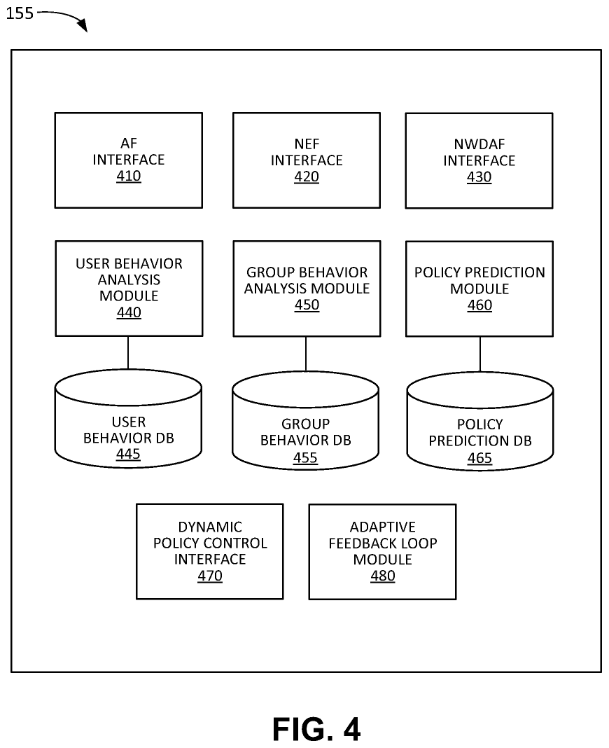

FIG. 4 is a diagram illustrating exemplary components of adaptive policy system 155. The components of adaptive policy system 155 may be implemented, for example, via processor 320 executing instructions from memory 330. For example, one or more components of adaptive policy system 155 may correspond to the structure of processor 320 together with instructions in memory 330 for implementing the functionality of the component. Alternatively, or additionally, some or all of the components of adaptive policy system 155 may be implemented via hardwired circuitry. For example, one or more components of adaptive policy system 155 may correspond to the structure of some or all of an ASIC, FPGA, and/or another type of integrated circuit. As shown in FIG. 4, adaptive policy system 155 may include an AF interface 410, an NEF interface 420, an NWDAF interface 430, a user behavior analysis module 440, a user behavior database (DB) 445, a group behavior analysis module 450, a group behavior DB 455, a policy prediction module 460, a policy prediction DB 465, a dynamic policy control interface 470, and an adaptive feedback loop module 480.

AF interface 410 may be configured to interface with AF 250. For example, adaptive policy system 155 may receive a request to generate a policy from application server 165 via AF 250, receive a request for information relating to a generated policy from application server 165 via AF 250, provide information relating to a generated policy from application server 165 via AF 250, etc. NEF interface 420 may be configured to interface with NEF 260 and adaptive policy system 155 may access exposed capabilities of core network 150 via NEF interface 420. For example, adaptive policy system 155 may obtain UE device 110 usage data from particular NFs via NEF 260. NWDAF interface 430 may be configured to interface with NWDAF 268. For example, adaptive policy system 155 may receive usage data relating to particular KPIs for particular UE devices 110 from NWDAF 268 via NWDAF interface 430.

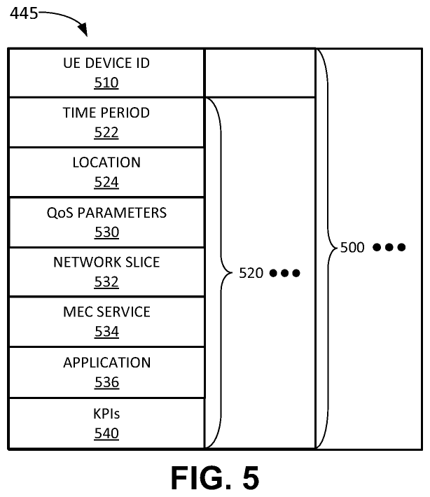

User behavior analysis module 440 may analyze user behavior of individual users associated with particular UE devices 110. User behavior analysis module 440 may collect user behavior data for UE device 110, determine a user behavior pattern for UE device 110 associated with the user based on the collected user behavior data, store information relating to the determined user behavior pattern in user behavior DB 445, and provide the information relating to the determined user behavior pattern to policy prediction module 460. Exemplary information that may be stored in user behavior DB 445 is described below with reference to FIG. 5.

Group behavior analysis module 450 may define a user group. In some implementations, group behavior analysis module 450 may receive a request to define a user group from application server 165 via AF 250. For example, application server 165 may request to define a user group for UE devices 110 associated with an enterprise (e.g., a business, organization, government entity, etc.), define a user group for UE devices 110 associated with a location (e.g., a residential area, a commercial area, etc.), define a user group for UE devices 110 using an application provided by application server 165, define a user group for UE devices 110 corresponding to a device type (e.g., a particular make and model, operating system, wireless chipset, etc.), and/or define a user group for UE devices 110 using a different criterion. In other implementations, user groups may be defined automatically by group behavior analysis module 450 for user groups described above. In yet other implementations, user groups may be defined automatically by group behavior analysis module 450 by identifying clusters of UE devices 110 using a clustering algorithm, such as, for example, a K-Means algorithm, a DBSCAN algorithm, a Gaussian Mixture Model algorithm, a Balance Iterative Reducing and Clustering (BIRCH) algorithm, an Ordering Points to Identify the Clustering Structure (OPTICS) algorithm, etc.

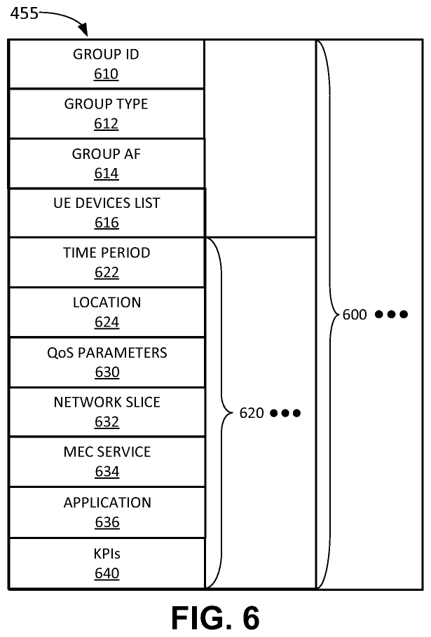

Group behavior analysis module 450 may collect group user behavior data for UE devices 110 associated with the user group, determine a user group behavior pattern for UE devices 110 associated with the user group based on the collected user group behavior data, store information relating to the determined user group behavior pattern in group behavior DB 455, and provide the information relating to the determined user group behavior pattern to policy prediction module 460. Exemplary information that may be stored in group behavior DB 455 is described below with reference to FIG. 6.

Policy prediction module 460 may generate an adaptive policy for particular UE devices 110 and/or defined groups of UE devices 110 based on information received from user behavior analysis module 440 and/or group behavior analysis module 450. In some implementations, policy prediction module 460 may map a set of user or group user parameter values during a time period to a policy using a lookup table.

In other implementations, policy prediction module 460 may use a trained machine learning model to select a policy based on a set of user or group user parameter values during a time period. For example, policy prediction module 460 my use a DQN to generate a policy for particular UE devices 110 and/or defined groups of UE devices 110. A DQN may use deep learning to approximate a Bellman optimality equation (referred to as an optimal Q-function) using a set of parameters. The Q-function of a policy may measure an expected return from a starting state by taking an action and following the policy after the action is taken. An optimal-function satisfies the Bellman optimality equation. Policy prediction module 460 may use the DQN to seek a policy that maximizes rewards corresponding to the user or user group behavior pattern. Thus, the rewards of the DQN agent may be to reserve adequate resources and/or assign appropriate data flow parameters, filters, and/or destinations in core network 150 to meet the requirements of a user or user group behavior during a time period, such as requirements relating to latency, throughput, number of available connections, etc.

Policy prediction DB 465 may store information relating to adaptive policies generated by policy prediction module 460. For example, for each generated policy, policy prediction DB 465 may store a policy record that identifies a policy, identifies whether the policy is associated with a single UE device 110 or a group of UE devices 110, identifies one or more UE devices 110 associated with the policy, and/or identifies, for user group policies, a type of group associated with a group of UE devices 110. Furthermore, the policy record may identify types and quantity of resources to reserve in connection with the policy; a guaranteed QoS parameter associated with the policy; whether the policy is associated with a network slice; whether the policy is associated with a MEC service, a DNN, and/or another type of destination; an application associated with the policy; one or more guaranteed KPI values associated with the policy; one or more filters associated with the policy; one or more KPIs to report for a data flow associated with the policy; and/or other types of requirements associated with the policy. Additionally, the policy may store information relating to the performance associated with the policy, such as one or more KPI values collected/obtained in connection with the policy.

Dynamic policy control interface 470 may be configured to instruct PCF 254 to implement a generated policy for UE device 110 and/or for a group of UE devices 110. Furthermore, dynamic policy control interface 470 may be configured to adjust a policy generated for UE device 110 and/or for a group of UE devices 110 based on performance information determined for the generated policy.

Adaptive feedback loop module 480 may adapt a generated policy based on performance of the generated policy. For example, adaptive feedback loop module 480 may monitor a generated policy and collect KPI values for UE devices 110 associated with the generated policy from NWDAF interface 430, from PCF 254 via dynamic policy control interface 40, from application server 165 via AF interface 410, from NEF 260 via NEF interface 420, and/or from other sources in core network 150 and/or RAN 130. Adaptive feedback loop module 480 may compare the obtained/collected KPI values to the requirements associated with the policy to determine whether the policy is satisfying the requirements. If the requirements are not being satisfied, adaptive feedback loop module 480 may adjust the policy to meet the requirements (e.g., by increasing a throughput, changing a QoS parameter, etc.).

Although FIG. 4 shows exemplary components of adaptive policy system 155, in other implementations, adaptive policy system 155 may include fewer components, different components, additional components, or differently arranged components than depicted in FIG. 4. Additionally, or alternatively, one or more components of adaptive policy system 155 may perform one or more tasks described as being performed by one or more other components of adaptive policy system 155.

FIG. 5 illustrates exemplary components of user behavior DB 445. As shown in FIG. 5, user behavior DB 445 may include one or more UE device records 500. Each UE device record 500 may store information relating to a particular UE device 110. UE device record 500 may include a UE device identifier (ID) field 510 and one or more time period records 520.

UE device ID field 510 may store information identifying a particular UE device 110. For example, UE device ID field 610 may store a Mobile Directory Number (MDN), an International Mobile Subscriber Identity (IMSI), a Mobile Station International Subscriber Directory Number (MSISDN), an International Mobile Equipment Identity (IMEI), an ID associated with the subscription for UE device 110 (e.g., a subscription ID, an account number, etc.), and/or another type of ID for the particular UE device 110.

Each time period record 520 may store information associated with a particular time period. For example, the time period may correspond to a time of day, day of week, time of year, etc. Time period record 520 may include a time period field 522, a location field 524, a QoS parameters field 530, a network slice field 532, a MEC service field 534, an application field 536, and a KPIs field 540. Time period field 522 may identify a time period. Location field 524 may store information identifying a location of UE device 110 during the time period.

QoS parameters field 530 may store one or more QoS parameters associated with UE device 110 during the time period. For example, QoS parameters field 530 may store a 5G QoS ID (5QI) value for a data flow associated with the UE device 110 during the time period. Furthermore, QoS parameters field 530 may store values for one or more additional QoS parameters for the data flow such as, for example, an Allocation and Retention Priority (ARP) value that defines a relative importance of data flow in light of resource limitations; a Reflective QoS Attribute (RQA) value that indicates whether QoS of downlink traffic to UE device 110 is reflected on uplink traffic; a Guaranteed Flow Bit Rate (GFBR) value; a Notification Control value that indicates whether notifications are requested from the RAN when the GFBR cannot be guaranteed; one or more Aggregate Maximum Bit Rate (AMBR) values, such as a per session AMBR, a per UE AMBR, etc.; a Maximum Packet Loss Rate (MPLR) value; and/or other types of QoS parameter values.

Network slice field 532 may store information identifying a network slice used by UE device 110 during the time period. MEC service field 534 may store information identifying whether UE device 110 used a MEC service during the time period and information identifying the MEC service, if UE device 110 used a MEC service during the time period. Application field 536 may store information identifying whether UE device 110 used an application during the time period and information identifying the application, if UE device 110 used an application during the time period.

KPIs field 540 may store one or more KPI values obtained/collected for UE device 110 during the time period. For example, KPI field 540 may store one or more values for core network KPIs, such as latency, throughput, packet loss rate, packet error rate, and/or other types of core network KPIs. For a particular core network KPI, KPI field 540 may store an average downlink value for the KPI, a maximum downlink value for the KPI, an average uplink value for the KPI, and/or a maximum uplink value for the KPI.

Furthermore, KPI field 540 may store one or more values for RAN KPIs, such as, for example, KPIs relating to wireless signal strength and/or quality (e.g., Reference Signal Received Power (RSRP), Reference Signal Received Quality (RSRQ), Received Signal Strength Indicator (RSSI), Signal to Interference and Noise Ratio (SINR), Channel Quality Information (CQI), Block Error Rate (BLER), and/or another KPI indicative of signal strength and/or quality value); KPIs relating to throughput and/or load for base station 120 servicing UE device 110, such as, for example, downlink average throughput, downlink maximum throughput, uplink average throughput, uplink maximum throughput, average spectral efficiency, maximum spectral efficiency, physical resource block (PRB) utilization rate, average processor load, average number of users, maximum number of users, a number of voice bearers, a number of video bearers, and/or another KPI indicative of throughput and/or load; accessibility KPIs (e.g., a Radio Resource Control (RRC) connection setup success rate, a Radio Access Bearer (RAB) success rate, etc.), retainability KPIs (e.g., a call drop rate, etc.), mobility KPIs (e.g., a handover success rate, etc.), and/or other types of RAN KPIs.

Although FIG. 5 shows exemplary components of user behavior DB 445, in other implementations, user behavior DB 445 may include fewer components, different components, additional components, or differently arranged components than depicted in FIG. 5.

FIG. 6 illustrates exemplary components of group behavior DB 455. As shown in FIG. 6, group behavior DB 455 may include one or more device group records 600. Each device group record 600 may store information relating to a particular group of UE devices 110. Group device record 600 may include a group ID field 610, a group type field 612, a group AF field 614, a UE devices list field 616, and one or more time period records 620.

Group ID field 610 may identify a user group. Group type field 612 may store information identifying a type of group associated with the user group. For example, group type field 612 may identify the type of group as an enterprise group (e.g., a business group, organization group, government entity group, etc.), a location group, a base station group, an application group, a device type group, an operating system group, a wireless chipset group, a group identified using a clustering algorithm, etc. Group AF field 614 may store information identifying an AF 250 and/or application server 165 associated with the user group. UE devices list field 616 may store a list of UE devices 110 included in the user group.

Each time record 620 may store information associated with a particular time period, similarly to as described above with reference to time record 520 of FIG. 5. Time period record 620 may include a time period field 622, a location field 624, a QoS parameters field 630, a network slice field 632, a MEC service field 634, an application field 636, and a KPIs field 640. Time period field 622, location field 624, QoS parameters field 630, network slice field 632, MEC service field 634, application field 636, and KPIs field 640 may store information similar to the information describe above with respect to time period field 522, location field 524, QoS parameters field 530, network slice field 532, MEC service field 534, application field 536, and KPIs field 540, respectively.

Although FIG. 6 shows exemplary components of group behavior DB 455, in other implementations, group behavior DB 455 may include fewer components, different components, additional components, or differently arranged components than depicted in FIG. 6.

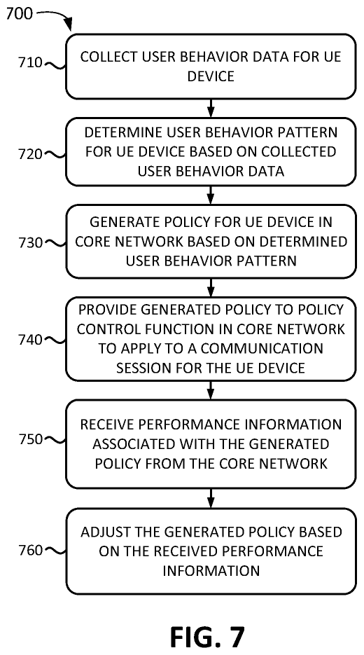

FIG. 7 illustrates a flowchart of a process 700 for generating a user policy in a core network. In some implementations, process 700 of FIG. 7 may be performed by adaptive policy system 155. In other implementations, some or all of process 700 may be performed by another device or a group of devices separate from adaptive policy system 155.

As shown in FIG. 7, process 700 may include collecting user behavior data for a UE device (block 710) and determining a user behavior pattern for the UE device based on the collected user behavior data (block 720). For example, adaptive policy system 155 may collect user behavior data for UE devices 110 from NWDAF 268, application server 165 via AF 250, PCF 254, NEF 260, and/or another component of core network 150 and/or RAN 130. Adaptive policy system 155 may store the collected user behavior data in user behavior DB 445 and may determine a user behavior pattern for particular UE devices 110 based on the collected user behavior data. For example, adaptive policy system 155 may map KPI values for UE device 110 over time and/or for different locations to determine whether there is a change in the KPI values during a particular time period, such as a time of day, day of week, etc., and/or whether there is a change in the KPI values at different locations visited by UE device 110. Adaptive policy system 155 may identify, as a user behavior pattern, time periods and/or locations associated with a change in KPI values indicating an increase in use of RAN 130 and/or core network 150 resources by UE device 110.

Process 700 may further include generating a policy for the UE device in a core network based on the determined user behavior pattern (block 730) and providing the generated policy to a PCF in the core network to apply to a communication session for the UE device (block 740). For example, adaptive policy system 155 may generate a policy that reserves resource for UE device 110 for time periods and/or locations associated with the determined user behavior pattern. The policy may reserve resources for guaranteeing a QoS parameter value, a data flow in a particular network slice, a data flow to a MEC service; guaranteeing a KPI value for a particular KPI for a data flow; guaranteeing a minimum throughput for a data flow; applying a filter to a data flow; reporting KPI value for particular KPI for a data flow; and/or reserving resource for another type of policy. Adaptive policy system 155 may provide the generated policy to PCF 254 associated with UE device 110. PCF 254 may implement the policy by sending instructions to SMF 240 associated with UE device 110 (e.g., for implementing a core network policy, etc.), by sending instructions to AMF 220 associated with UE device 110 (e.g., for implementing a RAN policy, etc.), and/or by sending a UE Route Selection Policy (URSP) to UE device 110 (e.g., to instruct UE device 110 to route PDUs associated with a particular label to a particular destination, etc.).

Process 700 may further include receiving performance information associated with the generated policy from the core network (block 750) and adjusting the generated policy based on the received performance information (block 760). For example, adaptive policy system 155 may monitor the generated policy and collect KPI values for UE device 110 from NWDAF 268, application server 165 via AF 250, PCF 254, NEF 260, and/or another component of core network 150 and/or RAN 130. Adaptive policy system 155 may compare the obtained/collected KPI values to the requirements associated with the policy to determine whether the policy is satisfying the requirements. If the requirements are not being satisfied, adaptive policy system 155 may modify the policy to meet the requirements (e.g., by increasing a throughput, changing a QoS parameter, etc.).

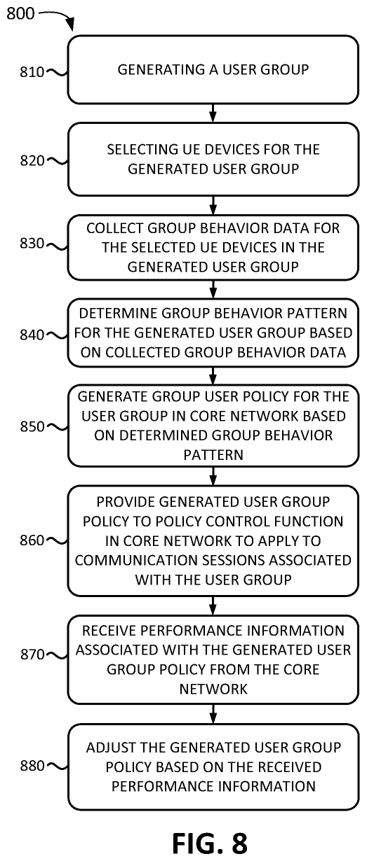

FIG. 8 illustrates a flowchart of a process 800 for generating a group user policy in a core network. In some implementations, process 800 of FIG. 8 may be performed by adaptive policy system 155. In other implementations, some or all of process 800 may be performed by another device or a group of devices separate from adaptive policy system 155.

As shown in FIG. 8, process 800 may include generating a user group (block 810) and selecting UE devices for the generated user group (block 820). For example, adaptive policy system 155 may receive a request to define a user group from application server 165 via AF 250, such as a request to define a user group for UE devices 110 associated with an enterprise, a location, an application, a device type, etc. As another example, adaptive policy system 155 may define a user group automatically based on UE devices 110 associated with an enterprise, a location, an application, a device type, etc. As yet another example, adaptive policy system 155 may define a user group by identifying a cluster of UE devices 110 using a clustering algorithm and KPI values collected for UE devices 110.

Process 800 may further include collecting group behavior data for a UE devices in the generated user group (block 830) and determining a group behavior pattern for the UE devices based on the collected group behavior data (block 840). For example, adaptive policy system 155 may collect user behavior data for UE devices 110 in the user group from NWDAF 268, application server 165 via AF 250, PCF 254, NEF 260, and/or another component of core network 150 and/or RAN 130. Adaptive policy system 155 may store the collected user behavior data in group behavior DB 455 and may determine a group behavior pattern for UE devices 110 in the user group based on the collected group behavior data, similarly as described above with block 720 of FIG. 7.

Process 800 may further include generating a group user policy for the user group in a core network based on the determined group behavior pattern (block 850) and providing the generated user group policy to a PCF in the core network to apply to a communication session for the UE device (block 860). For example, adaptive policy system 155 may generate a policy that reserves resource for UE devices 110 in the user group for time periods and/or locations associated with the determined user behavior pattern, similarly as described above with block 730 of FIG. 7. Adaptive policy system 155 may provide the generated policy to PCF 254 associated with UE device 110. PCF 254 may implement the policy by sending instructions to SMF 240 associated with UE devices 110 in the user group, by sending instructions to AMF 220 associated with UE devices 110 in the user group, and/or by sending a URSP to UE devices 110 in the user group.

Process 800 may further include receiving performance information associated with the generated policy from the core network (block 870) and adjusting the generated policy based on the received performance information (block 880). For example, adaptive policy system 155 may monitor the generated policy and collect KPI values for UE device 110 from NWDAF 268, application server 165 via AF 250, PCF 254, NEF 260, and/or another component of core network 150 and/or RAN 130. Adaptive policy system 155 may compare the obtained/collected KPI values to the requirements associated with the policy to determine whether the policy is satisfying the requirements. If the requirements are not being satisfied, adaptive policy system 155 may adjust the policy to meet the requirements (e.g., by increasing a throughput, changing a QoS parameter, etc.).

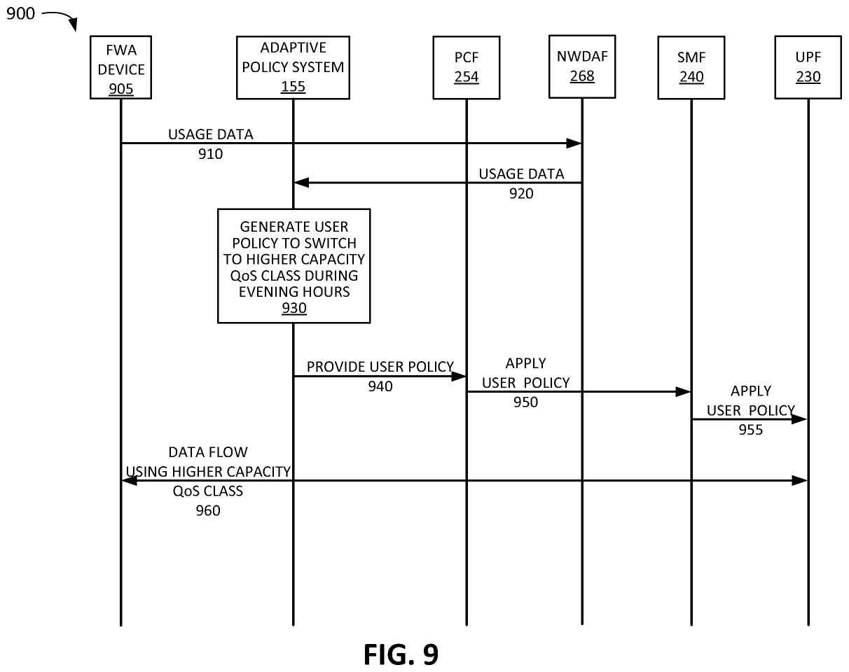

FIG. 9 illustrates a first exemplary signal flow 900 according to an implementation described herein. As shown in FIG. 9, signal flow 900 includes an FWA device 905 that functions as a WIFI AP for a customer premises network for a set of client devices. FWA device 905 may attach to base station 120 (not shown in FIG. 9) as UE device 110 and provide wireless connectivity to core network 150 for the client devices in the customer premises network. Customer premises network may experience peak usage during the evening hours when the residents are home and using the client devices.

Signal flow 900 may include FWA device 905 sending usage data to NWDAF 268 (signal 910) and NWDAF 268 may report the received usage data to adaptive policy system (signal 920). The usage data may include throughput data for different time periods (e.g., each minute, etc.), 5QIs for data flows associated with FWA device 905, maximum and average latencies for data flows associated with FWA device 905, and/or other KPI values. Adaptive policy system 155 may detect a usage pattern of higher data traffic during the evening hours and generate a policy to switch to a higher capacity QoS class during the evening hours (block 930).

Adaptive policy system 155 may provide the generated user policy to PCF 254 (signal 940) and PCF 254 may instruct SMF 240 to assign one or more data flows associated with FWA device 905 to the higher capacity QoS class during the evening hours (signal 950). SMF 240 may configure UPF 230 to implement the higher capacity QoS class for the data flows (signal 955). As a result, FWA device 905 may send and receive data flow traffic using the higher capacity QoS class (signal 960).

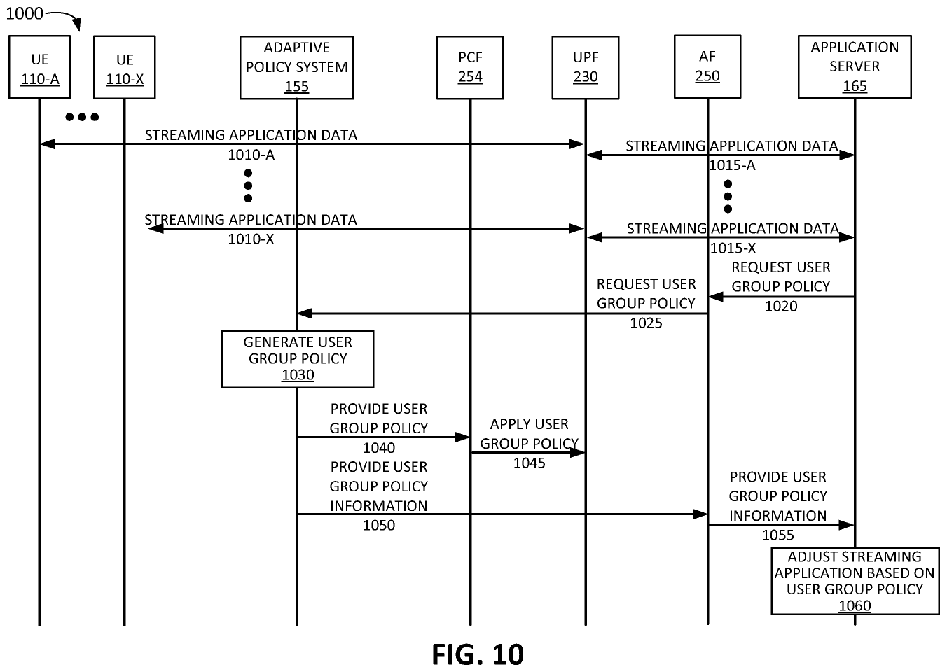

FIG. 10 illustrates a second exemplary signal flow 1000 according to an implementation described herein. As shown in FIG. 10, signal flow 1000 may include UE devices 110-A to 110-X streaming application data using a streaming application associated with application server 165 via base stations 120 (not shown in FIG. 10) and UPF 230 (signals 1010-A to 1010-X and 1015-A to 1015-X). Application server 165 may, at some point, send a request to adaptive policy system 155, via AF 250, to create a user group policy for UE devices 110 that use the streaming application (signals 1020 and 1025). The request for the user group policy may request a 5QI with a lower latency for the streaming application.

In response, adaptive policy system 155 may generate the user group policy for UE devices 110-A to 110-X (block 1030) and provide the generated user group policy to PCF 254 (signal 1040). PCF 254 may instruct SMF 240 (not shown in FIG. 10) to implement the policy on UPF 230 and SMF 230 may configure UPF 230 to implement the lower latency 5QI for the streaming application (signal 1045). Adaptive policy system 155 may further provide information relating to the user group policy to application server 165 via AF 250 (signals 1050 and 1055), indicating that the user group policy was generated and implemented. In response, application server 165 may adjust the streaming application based on the generated user group policy to optimize the streaming application based on the lower latency 5QI (block 1060).

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while a series of blocks have been described with respect to FIGS. 7 and 8, and a series of signals have been described with respect to FIGS. 9 and 10, the order of the blocks, and/or signals, may be modified in other implementations. Further, non-dependent blocks and/or signals may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

The term “logic,” as used herein, may refer to a combination of one or more processors configured to execute instructions stored in one or more memory devices, may refer to hardwired circuitry, and/or may refer to a combination thereof. Furthermore, a logic may be included in a single device or may be distributed across multiple, and possibly remote, devices.

For the purposes of describing and defining the present invention, it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

To the extent the aforementioned embodiments collect, store, or employ personal information of individuals, it should be understood that such information shall be collected, stored, and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A method comprising:
collecting, by a device, user behavior data associated with a user equipment (UE) device;
determining, by the device, a user behavior pattern for the UE device based on the collected user behavior data;
generating, by the device, a policy in a core network for the UE device based on the determined user behavior pattern for the UE device, wherein the core network manages a communication session for the UE device via a Radio Access Network (RAN); and
providing, by the device, the generated policy to a Policy Control Function (PCF) in the core network to apply to the communication session for the UE device.

2. The method of claim 1, wherein the user behavior data includes information identifying, for a location and a time period, at least one of:
a Quality of Service (QOS) parameter for a data flow associated with the UE device,
a network slice used by the UE device,
a Multi-Access Edge Computing (MEC) service used by the UE device,
an application used by the UE device,
a core network key performance indicator (KPI) value for a data flow associated with the UE device, or
a RAN KPI value for a data flow associated with the UE device.

3. The method of claim 1, wherein the generated policy in the core network for the UE device includes a policy to reserve resources for at least one of:
guaranteeing a Quality of Service (QOS) parameter value during a time period,
a data flow in network slice during the time period,
a data flow to a Multi-Access Edge Computing (MEC) service during the time period,
guaranteeing a key performance indicator (KPI) value for a data flow during the time period,
guaranteeing a minimum throughput for a data flow during the time period,
applying a filter to a data flow during the time period, or
reporting a key performance indicator (KPI) value for a data flow during the time period.

4. The method of claim 1, wherein generating the policy in the core network for the UE device includes:
using a Deep Q-Learning Network (DQN) to generate the policy for the UE device in the core network based on the user behavior pattern for the UE device.

5. The method of claim 1, further comprising:
selecting a group of UE devices;
collecting group user behavior data associated with the group of UE devices;
determining a group user behavior pattern for the group of UE device based on the collected group user behavior data;
generating a user group policy in the core network for the group of UE devices; and
providing the generated user group policy to the PCF in the core network to apply to communication sessions associated with the group of UE devices.

6. The method of claim 5, wherein selecting the group of UE devices includes:
selecting a plurality of UE devices managed by an enterprise;
selecting a plurality of UE devices associated with a same location;
selecting a plurality of UE devices attached to a same base station;
selecting a plurality of UE devices that installed a same application;
selecting a plurality of UE devices associated with a same device type;
selecting a plurality of UE devices associated with a same operating system; or
selecting a plurality of UE devices associated with a same radio frequency transceiver processor.

7. The method of claim 5, wherein selecting the group of UE devices includes:
identifying a cluster of UE devices using a clustering algorithm.

8. The method of claim 1, further comprising:
providing an interface to an Application Function (AF) to enable the AF to request the policy for the UE device.

9. The method of claim 8, further comprising:
receiving, from the AF via the provided interface, a request to generate a user group policy in the core network for a group of UE devices for a time period.

10. The method of claim 1, wherein providing the generated policy to the PCF in the core network to apply to the communication session for the UE device is performed via an interface provided by the PCF to receive dynamic policy control information from the core network.

11. The method of claim 1, further comprising:
receiving performance information associated with the generated policy from the core network; and
adjusting the generated policy for the UE device based on the received performance information using a reinforcement learning model.

12. A device comprising:
a processor configured to:
collect user behavior data associated with a user equipment (UE) device;
determine a user behavior pattern for the UE device based on the collected user behavior data;
generate a policy in a core network for the UE device based on the determined user behavior pattern for the UE device, wherein the core network manages a communication session for the UE device via a Radio Access Network (RAN); and
provide the generated policy to a Policy Control Function (PCF) in the core network to apply to the communication session for the UE device.

13. The device of claim 12, wherein the user behavior data includes information identifying, for a location and a time period, and at least one of:
a Quality of Service (QOS) parameter for a data flow associated with the UE device,
a network slice used by the UE device,
a Multi-Access Edge Computing (MEC) service used by the UE device,
an application used by the UE device,
a core network key performance indicator (KPI) value for a data flow associated with the UE device, or
a RAN KPI value for a data flow associated with the UE device.

14. The device of claim 12, wherein the generated policy in the core network for the UE device includes a policy to reserve resources for at least one of:
guaranteeing a Quality of Service (QOS) parameter value during a time period,
a data flow in network slice during the time period,
a data flow to a Multi-Access Edge Computing (MEC) service during the time period,
guaranteeing a key performance indicator (KPI) value for a data flow during the time period,
guaranteeing a minimum throughput for a data flow during the time period,
applying a filter to a data flow during the time period, or
reporting a key performance indicator (KPI) value for a data flow during the time period.

15. The device of claim 12, wherein, when generating the policy in the core network for the UE device, the processor is further configured to:
use a Deep Q-Learning Network (DQN) to generate the policy for the UE device based on the user behavior pattern for the UE device.

16. The device of claim 12, wherein the processor is further configured to:
select a group of UE devices;
collect group user behavior data associated with the group of UE devices;
determine a group user behavior pattern for the group of UE device based on the collected group user behavior data;
generate a user group policy in the core network for the group of UE devices; and
provide the generated user group policy to the PCF in the core network to apply to communication sessions associated with the group of UE devices.

17. The device of claim 16, wherein, when selecting the group of UE devices, the processor is configured to:
select a plurality of UE devices managed by an enterprise;
select a plurality of UE devices associated with a same location;
select a plurality of UE devices attached to a same base station;
select a plurality of UE devices that installed a same application;
select a plurality of UE devices associated with a same device type;
select a plurality of UE devices associated with a same operating system; or
select a plurality of UE devices associated with a same radio frequency transceiver processor.

18. The device of claim 16, wherein, when selecting the group of UE devices, the processor is configured to:
identify a cluster of UE devices using a clustering algorithm.

19. The device of claim 12, wherein the processor is further configured to:
provide an interface to an Application Function (AF) to enable the AF to request the policy in the core network for the UE device; and
receive, from the AF via the provided interface, a request to generate a user group policy in the core network for a group of UE devices for a time period.

20. A non-transitory computer-readable memory device storing instructions executable by a processor, the non-transitory computer-readable memory device comprising:
one or more instructions to collect user behavior data associated with a user equipment (UE) device;
one or more instructions to determine a user behavior pattern for the UE device based on the collected user behavior data;
one or more instructions to generate a policy in a core network for the UE device based on the determined user behavior pattern for the UE device, wherein the core network manages a communication session for the UE device via a Radio Access Network (RAN); and
one or more instructions to provide the generated policy to a Policy Control Function (PCF) in the core network to apply to the communication session for the UE device.
